(19) United States
(12) Patent Application Publication
(10) Pub. No.: US 2002/0073748 A1
(43) Pub. Date: Jun. 20, 2002

(54) All-purpose burglarproof device of steering wheel and safety air bag

(76) Inventor: Hui I. Ho, Taipei Hsien (TW)

Correspondence Address: Rosenberg, Klein & Lee, Suite 105, 3444 Ellicott Center Drive, Ellicott City, MD, 21043, US

(21) Appl. No.: 09/737,464

(22) Filed: Dec. 18, 2000

(51) Int. Cl. B60R 25/00; B62H 5/00

(52) U.S. Cl. 70/209; 180/287

(57) ABSTRACT

The present invention proposes an all-purpose burglarproof device of steering wheel and safety air bag. The burglarproof device of the present invention comprises a first plate body, a connecting plate body, a second plate body, and at least a locking device. The first plate body has a first hook element and a first opening. One side of the first plate body is pivotally joined with the connecting plate body. The second plate body has a second hook element and a second opening respectively symmetric to the first hook element and the first opening. Recessed slide grooves are formed on the bottom surface of the second plate body to match slide blocks of the connecting plate body. The locking device fixedly locks the burglarproof device over a steering wheel so that the burglarproof device can exactly cover above the position where the safety air bag is installed.

### FIELD OF THE INVENTION

The present invention relates to an all-purpose burglarproof device of steering wheel and safety air bag and, more particularly, to an all-purpose burglarproof device, which has burglarproof function for the safety air bag, can be adjusted to a proper position according to the size of the steering wheel, can be firmly locked over the steering wheel, and can exactly cover above the position where the air bag is installed. Thereby, the all-purpose burglarproof device of steering wheel and air bag of the present invention will have better burglarproof effect, and can be easily stowed in a car.

### BACKGROUND OF THE INVENTION

Nowadays, cars usually have safety air bags installed therein so as to secure the lives of drivers when accidents occur. The safety air bag is very expensive. A general burglarproof lock of car can only prevent the car from being stolen, but cannot prevent a burglar from breaking in and stealing the safety air bag. When a burglar cannot steal the car, he often steals the safety air bag installed below the steering wheel. That is, a prior art burglarproof lock of car has no burglarproof function for the safety air bag so that the safety air bag can be easily stolen. Therefore, burglarproof devices of steering wheel have been proposed to overcome this problem.

As shown in FIG. 1, a prior art burglarproof device of steering wheel is a plate body 1a having a shape similar to that of the steering wheel. A circular arc part 10a is formed at each side of the plate body 1a. A hook element 12a is formed on each of the two circular arc parts 10a. A plurality of openings 11a are formed on the plate body 1a adjacent to the two circular arc parts 10a. Thereby, the two hook elements 12a can hook and press at two side edges of the steering wheel. A lock tool penetrates through the openings 11 a of the plate body 1a and is fixedly locked over the steering wheel so that the burglarproof device of steering wheel can cover above the position where the safety air bag is installed. It is thus difficult for a burglar to steal the safety air bag.

Although the burglarproof device of steering wheel can improve the drawbacks of a prior art burglarproof lock of car and can cover above the position where the safety air bag is installed to prevent a burglar from stealing the safety air bag, it is too bulky and cannot be easily stowed in a car. Moreover, because the sizes of steering wheels of cars differ, a user must buy a burglarproof device of steering wheel having a size conforming to the steering wheel of his car. Otherwise, when the burglarproof device of steering wheel is locked over the steering wheel, if the steering wheel is too small, the burglarproof device of steering wheel cannot be firmly locked over the steering wheel so that a burglar has the opportunity of stealing; if the steering wheel is too large, the burglarproof device of steering wheel cannot hook and press at two side edges of the steering wheel by means of the two hook elements so that it is useless. Because prior art burglarproof devices of steering wheel have no strict burglarproof effect and cannot be easily stowed or placed in a car, they have not been widely accepted.

### SUMMARY OF THE INVENTION

The primary object of the present invention is to provide an all-purpose burglarproof device of steering wheel and safety air bag. The burglarproof device comprises a first plate body, a connecting plate body, a second plate body, and at least a locking device. The first plate body and the second plate body are adjusted to match the size of the steering wheel through a slide block on the connecting plate body. The surfaces of the first plate body and the second plate body can be used to exactly cover above the position where the safety air bag is installed for protection. The locking device is used to fixedly lock the burglarproof device over the steering wheel so that a burglar will have difficulty of stealing the safety air bag installed below the steering wheel. A crutch lock can further be matched so as to achieve burglarproof function for both the car and the safety air bag.

Another object of the present invention is to provide an all-purpose burglarproof device of steering wheel and safety air bag, wherein the first plate body and the second plate body are bent downwards and folded to reduce the unfolded area by means of a pivotal shaft through which the first plate body and the connecting plate body are pivotally joined. Thereby, the burglarproof device can be bent and folded to occupy less space when not used so that it can be conveniently stowed in a car. The various objects and advantages of the present invention will be more readily understood from the following detailed description when read in conjunction with the appended drawings, in which:

### BRIEF DESCRIPTION OF THE DRAWINGS:

FIG. 1 is a perspective view of a prior art burglarproof device of steering wheel;

FIG. 2 is an exploded perspective view of the present invention;

FIG. 3 is a perspective view showing a use state of the present invention;

FIG. 4 is cross-sectional view showing a use state of the present invention;

FIG. 5 is a perspective view showing another use state of the present invention;

FIG. 6A is a cross-sectional view when the present invention is unfolded;

FIG. 6B is a cross-sectional view when the present invention is folded;

FIG. 7 is a perspective view showing a use state according to another embodiment of the present invention;

FIG. 8 is an exploded perspective view according to another embodiment of the present invention;

FIG. 9 is a side cross-sectional view according to another embodiment of the present invention;

FIG. 10 is a perspective view when the first and second plate bodies of the present invention is superimposed according to another embodiment of the present invention; and

FIG. 11 is an exploded perspective view according to yet another embodiment of the present invention.

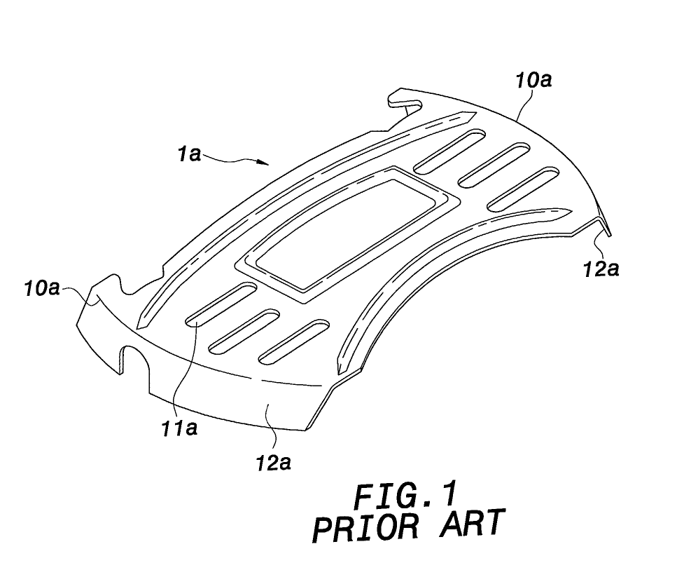

### DETAILED DESCRIPTION OF THE PREFERRED EMBODIMENTS

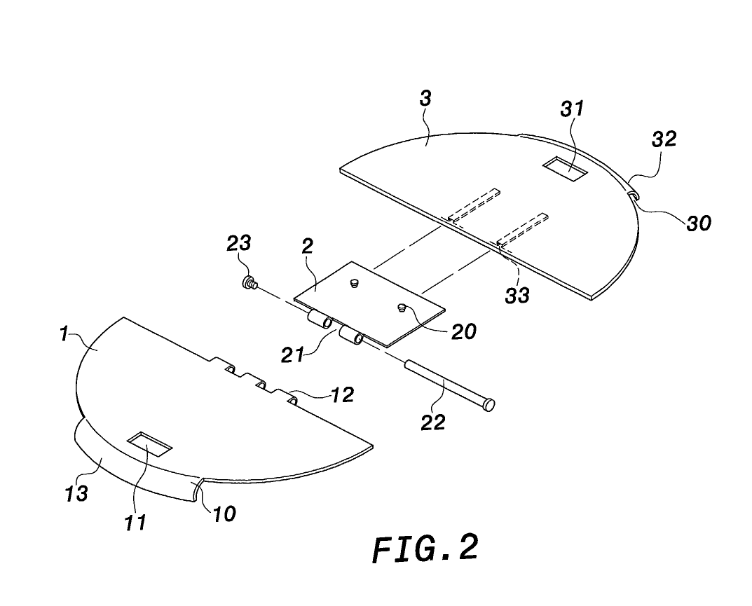

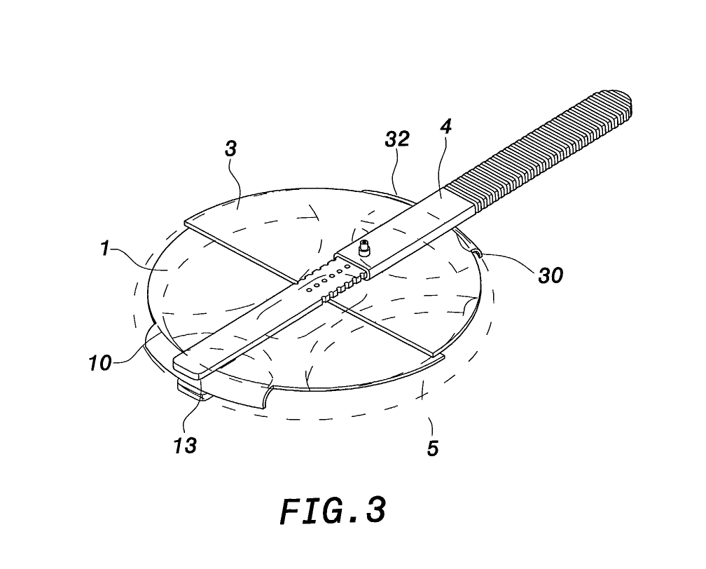

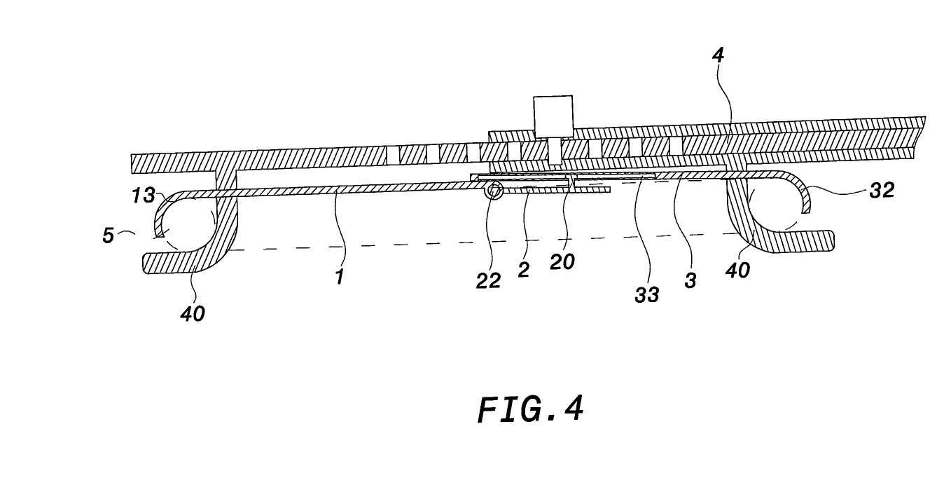

As shown in FIGS. 2 to 4, the present invention provides an all-purpose burglarproof device of steering wheel and safety air bag. The burglarproof device comprises a first plate body 1, a connecting plate body 2, a second plate body 3, and at least a locking device 4. The first plate body 1 is a flat plate body having a circular arc part 10 formed at one side thereof. A rectangular first opening 11 is formed on the first plate body 1. A pivotally-joining part 12 is formed at the side opposed to the circular arc part 10. A curved first hook element 13 is formed on the circular arc part 10.

The connecting plate body 2 is a flat rectangular plate body having projective slide blocks 20. A pivotally-joining part 21 is formed at one side of the connecting plate body 2. The pivotally-joining part 21 of the connecting plate body 2 and the pivotally-joining part 12 of the first plate body 1 are pivotally joined. A pivotal shaft 22 penetrates through the two pivotally-joining parts 12 and 21 and is fastened with a stud 23.

The second plate body 3 is also a flat plate body. A circular arc part 30 symmetric to the circular arc part 10 of the first plate body 1 is formed at one side of the second plate body 3. A second opening 31 symmetric to the first opening 11 of the first plate body 1 is formed on the second plate body. A second hook element 32 symmetric to the first hook element 13 of the first plate body 1 is formed on the circular arc part 30. Recessed slide grooves 33 matching the slide blocks 20 of the connecting plate body 2 are formed on the bottom surface of the second plate body 3. Through the slide blocks 20 sliding in the slide grooves 33, the second plate body 3 can slide on the connecting plate body 2 bi-directionally to adjust to a proper size so that the burglarproof device can match over a steering wheel 5.

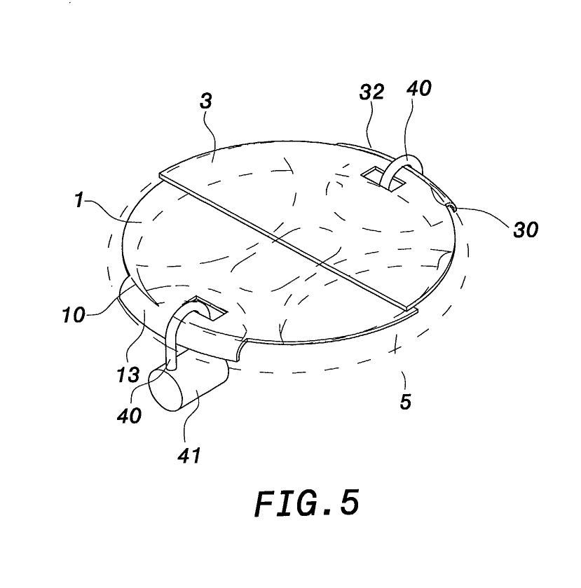

The locking device (crutch lock) 4 uses two hook elements 40 thereof to penetrate through the first opening 11 and the second opening 31, and to hook and press at two side edges of the steering wheel 5. Thereby, the burglarproof device can be fixedly locked over the steering wheel 5 so that the burglarproof function for both the car and the safety air bag can be achieved. The locking device 4 can also be a hang lock 41 or other lock tools to be fixedly locked at the first opening 11 and the second opening 31, as shown in FIG. 5.

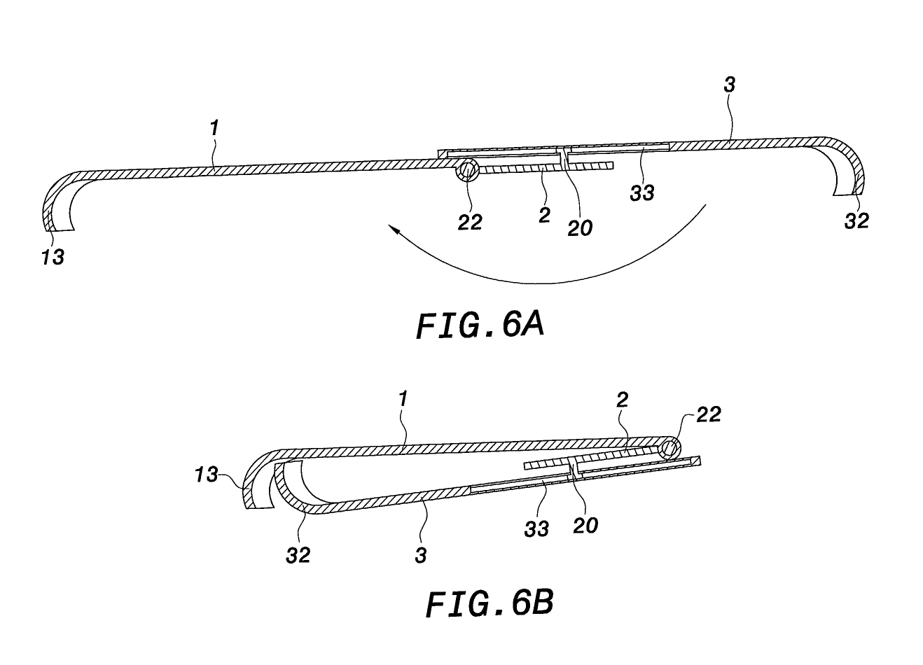

As shown in FIGS. 6A and 6B, when the present invention is detached form the steering wheel 5, it cannot be easily stowed and occupies much space if placed in a car because the unfolded area is larger. However, the first plate body 1 and the second plate body 3 can be bent downwards and folded to reduce the unfolded area by means of the pivotal shaft 22 through which the first plate body 1 and the connecting plate body 2 are pivotally joined. Thereby, the burglarproof device can be bent and folded to occupy less space when not used so that it can be conveniently stowed in a car.

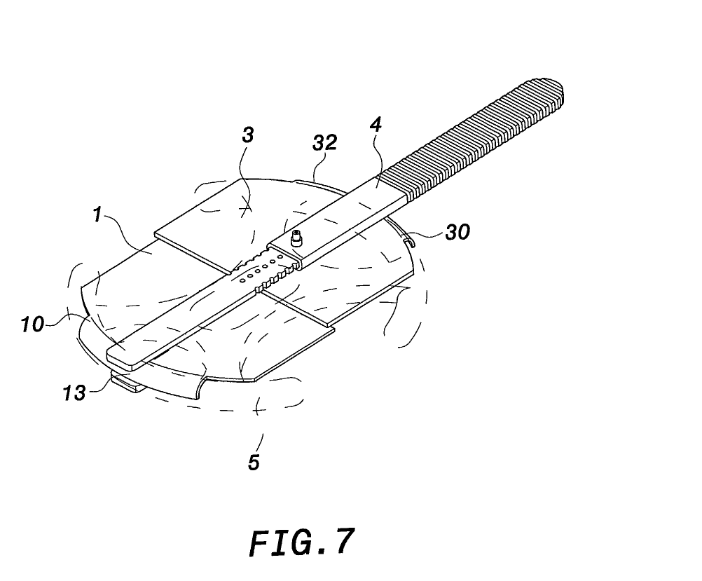

As shown in FIG. 7, the first plate body 1 and the second plate body 3 can have shapes corresponding to the shape of the steering wheel 5 so that the burglarproof device can match over the steering wheel 5.

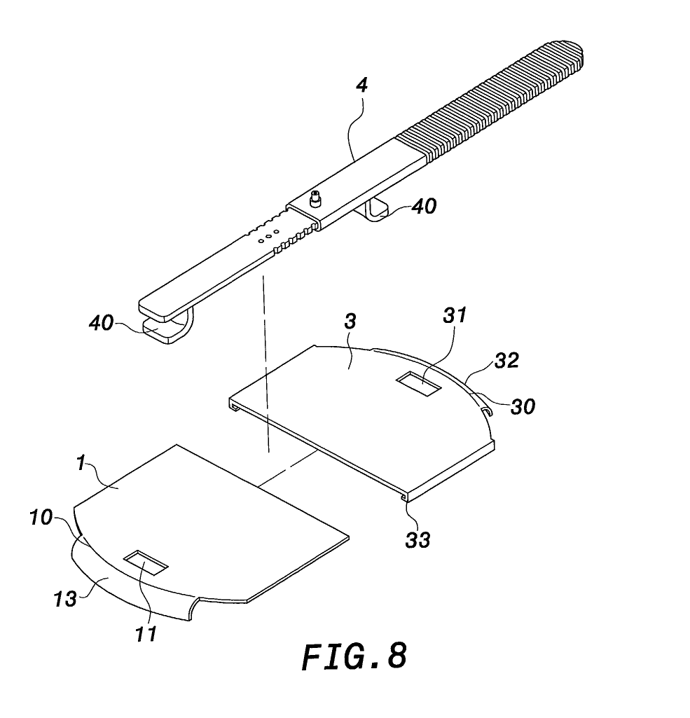

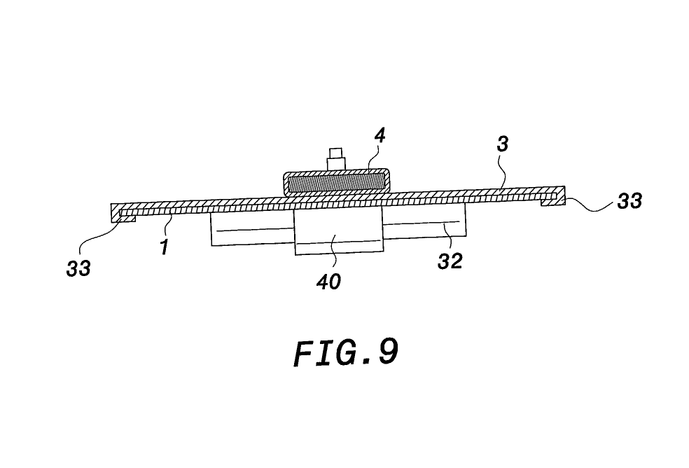

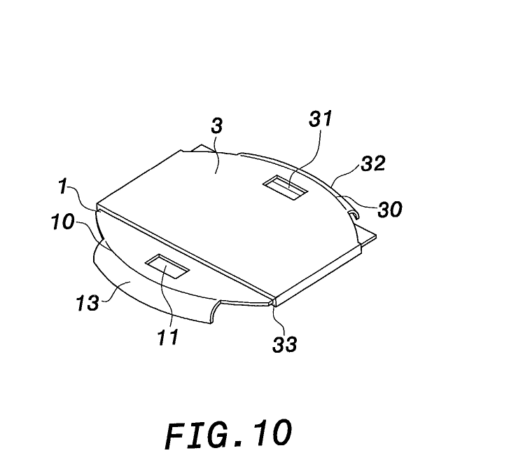

As shown in FIGS. 8 to 10, a pair of slide grooves 33 can be formed at two end edges of the bottom surface of the first plate body 1 or the second plate body 3 so that the first slide body 1 and the second plate body 3 can make bi-directional slide motion with respect to each other through the help of the slide grooves 33. Thereby, the burglarproof device of the present invention can be adjusted to a proper size so that it can match over the steering wheel 5. Moreover, the first plate body 1 and the second plate body 3 can be superimposed to reduce the unfolded area by means of this bi-directional slide motion so that the burglarproof device of the present invention can be conveniently stowed in a car.

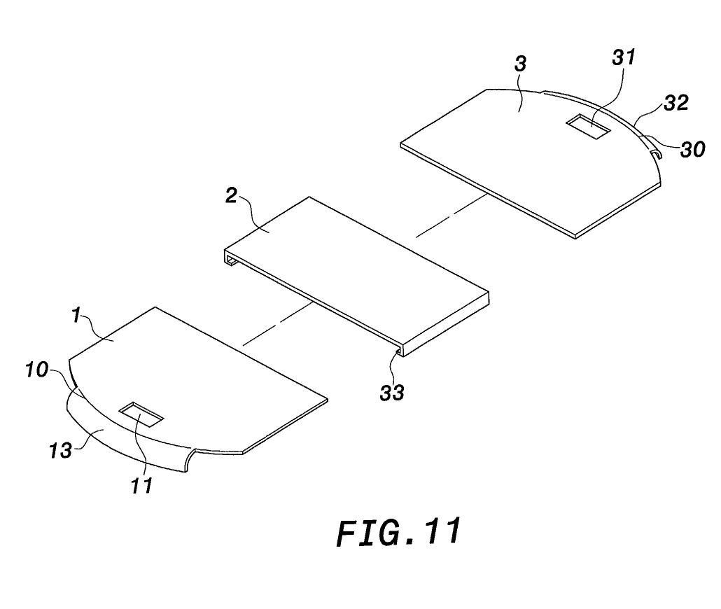

As shown in FIG. 11, a pair of slide grooves 33 can also be formed at two end edges of the bottom surface of the connecting plate body 2 so that the first slide body 1 and the second plate body 3 can make bi-directional slide motion in the slide grooves 33. Thereby, the burglarproof device of the present invention can be adjusted to a proper size so that it can match over the steering wheel 5. Moreover, the first plate body 1 and the second plate body 3 can be received in the slide grooves 33 of the connecting plate body 2 to reduce the unfolded area by means of this bi-directional slide motion so that the burglarproof device of the present invention can be conveniently stowed in a car.

To sum up, the larger surfaces of the first plate body 1 and the second plate body 3 can be used to exactly cover above the position where the safety air bag is installed for protection. Moreover, the contact area of the first hook element 13 and the second hook element 32 with the steering wheel 5 is larger. The second plate body 3 can bi-directionally slide on the connecting plate body 2 to adjust the burglarproof device to a proper size through the slide blocks 20 sliding in the slide grooves 33 so as to match over the steering wheel 5. The burglarproof device of the present invention can be fixedly locked over the steering wheel 5 so that a burglar will have difficulty of stealing the safety air bag installed below the steering wheel. A crutch lock can further be matched so as to achieve burglarproof function for both the car and the safety air bag. Furthermore, the burglarproof device of the present invention can be bent and folded or superimposed to reduce the unfolded area and to occupy less space when not used so that it can be conveniently stowed in a car.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. An all-purpose burglarproof device of steering wheel and safety air bag, comprising:
a first plate body having a circular arc part being formed at one side thereof, said circular arc part having a first hook element, a first opening being formed on said first plate body;
a second plate body having a second hook element and a second opening at one side thereof respectively symmetric to said first hook element and said first opening of said first plate body, said second plate body being slidably joined with said first plate body; and
at least a locking device, said locking device using hook elements thereof to respectively penetrate through said first opening and said second opening and to hook and press at two side edges of a steering wheel.

2. The all-purpose burglarproof device of steering wheel and safety air bag as claimed in claim 1, wherein slide grooves are formed at two end edges of the bottom surface of said first plate body or said second plate body.

3. The all-purpose burglarproof device of steering wheel and safety air bag as claimed in claim 1, wherein said first plate body and said second plate body can have corresponding shapes to match over a steering wheel.

4. The all-purpose burglarproof device of steering wheel and safety air bag as claimed in claim 1, wherein said locking device can be a crutch lock or a hang lock.

5. The all-purpose burglarproof device of steering wheel and safety air bag as claimed in claim 1, wherein a pivotally-joining part is formed at the other side of said first plate body, said pivotally-joining part being pivotally joined with a connecting plate body having projective slide blocks, recessed slide grooves being formed on said second plate body so that said slide blocks can match said slide grooves.

6. The all-purpose burglarproof device of steering wheel and safety air bag as claimed in claim 1, wherein said first plate body and said second plate body can be slidably joined through a connecting plate body, slide grooves being formed at two end edges of the bottom surface of said connecting plate body.
